(19) United States
(12) Patent Application Publication
(10) Pub. No.: US 2021/0129547 A1
(43) Pub. Date: May 6, 2021

(54) AERATE PRINT MATERIAL PARTICLES

(71) Applicant: HEWLETT-PACKARD DEVELOPMENT COMPANY, L.P., Spring, TX (US)

(72) Inventors: Jeffrey H. Luke, Boise, ID (US); Gabriel Scott McDaniel, Boise, ID (US); Mathew Lavigne, Boise, ID (US)

(21) Appl. No.: 17/259,671

(22) PCT Filed: Nov. 8, 2018
(86) PCT No.: PCT/US2018/059781

§ 371 Date: Jan. 12, 2021

(51) Int. Cl. B41J 2/175

(52) U.S. Cl. CPC B41J 2/17556; B41J 2/17506; B41J 2002/17516; B41J 2/17553; B41J 2/17513

(57) ABSTRACT

In some examples, a print material particles container can include a print material reservoir, a structure adapted to decrease a volume of the print material reservoir to provide an output of print material particles, and a pressure manipulation device adapted to be manipulated while the volume adapting structure is moved from a first position to a third position to aerate the print material particles.

### BACKGROUND

Imaging systems, such as printers, copiers, etc., may be used to form markings on a physical medium, such as text, images, etc. In some examples, imaging systems may form markings on the physical medium by performing a print job. A print job can include forming markings such as text and/or images by transferring print material particles to the physical medium.

### BRIEF DESCRIPTION OF THE DRAWINGS

FIG. 1 illustrates a cross-sectional side view of an example of a print material particles container consistent with the disclosure.

FIG. 2 illustrates a cross-sectional side view of an example of a print material particles container having a volume adapting structure in various positions consistent with the disclosure.

FIG. 3 illustrates a cross-sectional side view of an example of print material particles container having a rupturable barrier consistent with the disclosure.

FIG. 4 illustrates a cross-sectional side view of an example of print material particles container having a rupturable barrier consistent with the disclosure.

FIG. 5 illustrates a cross-sectional side view of an example of print material particles container having a translating bias gate consistent with the disclosure.

FIG. 6 illustrates a cross-sectional side view of an example of print material particles container having a translating bias gate consistent with the disclosure.

FIG. 7 illustrates a cross-sectional side view of an example of print material particles container having a rotating bias gate consistent with the disclosure.

FIG. 8 illustrates a cross-sectional side view of an example of print material particles container having a rotating gate and latch consistent with the disclosure.

FIG. 9 illustrates a cross-sectional side view of an example of print material particles container having a rupturable material consistent with the disclosure.

### DETAILED DESCRIPTION

Imaging devices may include a supply of a print material particles located in a reservoir. As used herein, the term “print material particles” refers to a substance which, when applied to a medium, can form representation(s) on the medium during a print job. In some examples, the print material particles can be deposited in successive layers to create three-dimensional (3D) objects. For example, print material particles can include a powdered semi-crystalline thermoplastic material, a powdered metal material, a powdered plastic material, a powdered composite material, a powdered ceramic material, a powdered glass material, a powdered resin material, and/or a powdered polymer material, among other types of powdered or particulate material. The print material particles can be particles with an average diameter of less than one hundred microns. For example, the print material particles can be particles with an average diameter of between 0-100 microns. However, examples of the disclosure are not so limited. For example, print material particles can be particles with an average diameter of between 20-50 microns, 5-10 microns, or any other range between 0-100 microns. The print material particles can be fused when deposited to create 3D objects.

The print material particles can be deposited onto a physical medium. As used herein, the term “imaging device” refers to any hardware device with functionalities to physically produce representation(s) on the medium. In some examples, the imaging device can be a 3D printer. For example, the 3D printer can create a representation (e.g., a 3D object) by depositing print material particles in successive layers to create the 3D object.

The reservoir including the print material particles may be inside of the imaging device and include a supply of the print material particles such that the imaging device may draw the print material particles from the reservoir as the imaging device creates the images on the print medium. As used herein, the term “reservoir” refers to a container, a tank, and/or a similar vessel to store a supply of the print material particles for use by the imaging device.

As the imaging device draws the print material particles from the reservoir, the amount of print material particles in the reservoir may deplete. As a result, the amount of print material particles in the reservoir of the imaging device may have to be replenished.

A print material particles container may be utilized to fill and/or refill the reservoir of the imaging device with print material particles. During a fill and/or refill operation, the print material particles container can transfer print material particles from the print material particles container to the reservoir of the imaging device.

Utilizing a print material particles container for a fill operation can allow a user to fill a printing device with print material particles. However, print material particles included in a print material particles container can compact. For example, if a print material particles container is stored for filling a printing device at a later time, the print material particles can compact, and as such, may not flow readily from an orifice of the print material particles container. Shaking, stirring, or otherwise agitating the print material particles can take additional time, and may not be done correctly and/or sufficiently, which may result in improper flow, movement, and/or transfer of print material particles. As a result, print jobs may be delayed and/or result in reduced utilization of print material particles.

Accordingly, aerate print material particles can allow for aeration of print material particles in the print material particles container. The print material particles can be aerated to allow for ease of flow, movement, and/or transfer of print material particles from the print material particles container. Aeration of the print material particles can prevent having to shake, stir, or otherwise agitate the print material particles. As a result, print material particles can quickly and easily be provided to the imaging device, and the imaging device can continue to perform print jobs as a result.

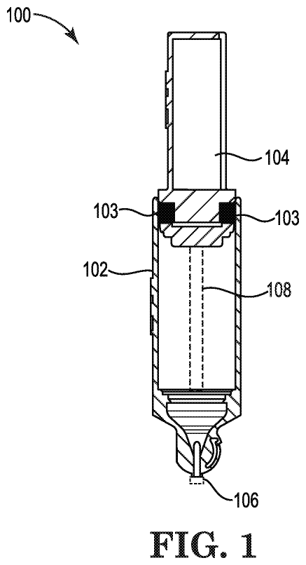

FIG. 1 illustrates a cross-sectional side view of an example of a print material particles container 100 consistent with the disclosure. Print material particles container 100 can include print material reservoir 102, seal member 103, volume adapting structure 104, pressure manipulation device 106, and push actuator 108.

As illustrated in FIG. 1, print material particles container 100 can include a print material reservoir 102. As used herein, the term “print material reservoir” refers to a container to store a supply of print material particles. For example, print material reservoir 102 can include print material particles for output to a printing device.

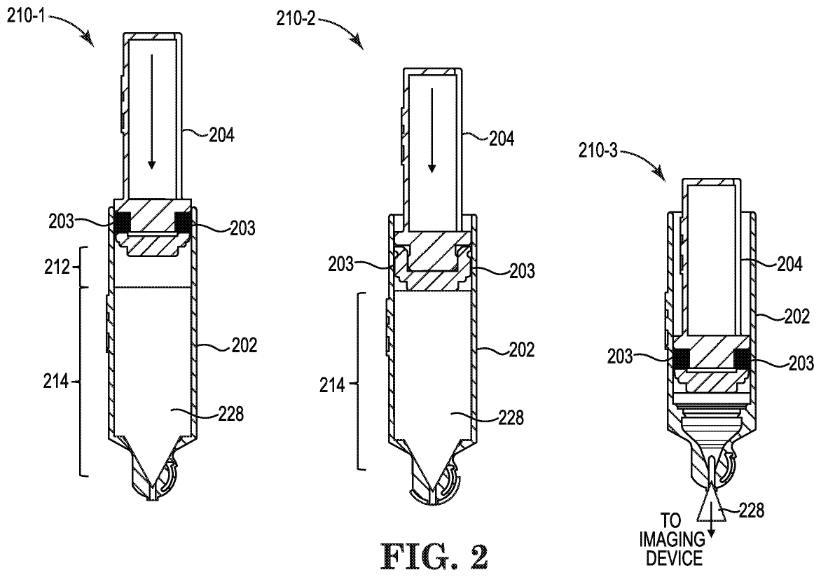

Print material particles container 100 can include a structure 104 adapted to decrease a volume of print material reservoir 102. As used herein, the term “volume adapting structure” refers to a piston to expel print material particles through an output at the end of print material particles reservoir 102 to an imaging device. For example, volume adapting structure 104 can decrease a volume of print material reservoir 102 to cause an output of print material particles to an input of an imaging device, as is further described in connection with FIG. 2.

Volume adapting structure 104 can include a seal member 103. As used herein, the term “seal” refers to preventing material flow between a first location and a second location. As used herein, the term “member” refers to a constituent part of mechanism that prevents communication of material. For example, the seal member 103 can prevent the flow of print material particles around volume adapting structure 104. In some examples, the seal member 103 can be an elastomeric material, among other types of materials. The seal member 103 can hold the pressure in the print material particles reservoir 102 created by depressing volume adapting structure 104 and ensure that print material particles are forced into an imaging device through an outlet of print material particles container 100 and not around volume adapting structure 104 and into the ambient environment.

As described above, print material particles container 100 can include a print material reservoir 102 and a volume adapting structure 104. That is, print material particles container 100 can be a syringe. As used herein, the term “syringe” refers to a reciprocating pump including a plunger (e.g., volume adapting structure 104) and a tube (e.g., print material reservoir 102), where the plunger can be linearly moved to allow the syringe to expel material (e.g., print material particles) through an orifice at the end of the tube. The orifice can be a print material output. As used herein, the term “print material output” refers to an opening through which print material particles can be moved. For example, the print material output can be an opening through which print material particles can be moved in response to volume adapting structure 104 decreasing a volume of print material reservoir 102 based on movement of volume adapting structure 104 in print material reservoir 102.

Print material particles container 100 can include a pressure manipulation device 106. As used herein, the term “pressure manipulation device” refers to a mechanism to allow flow of print material particles based on a pressure inside of print material reservoir 102. For example, the pressure manipulation device 106 can allow the flow of print material particles from print material reservoir 102 to an imaging device in response to the pressure in print material reservoir 102 exceeding a threshold pressure, as is further described in connection with FIGS. 2-9. Pressure manipulation device 106 can be adapted to be manipulated while the volume adapting structure 104 is being moved from a first position to a third position to aerate the print material particles, as is further described in connection with FIG. 2.

Print material particles container 100 can include push actuator 108. As used herein, the term “push actuator” refers to a slender projecting device to interact with pressure manipulation device 106. In some examples, push actuator 108 can rupture pressure manipulation device 106. In some examples, push actuator 108 can contact pressure manipulation device 106 to cause pressure manipulation device 106 to be in motion.

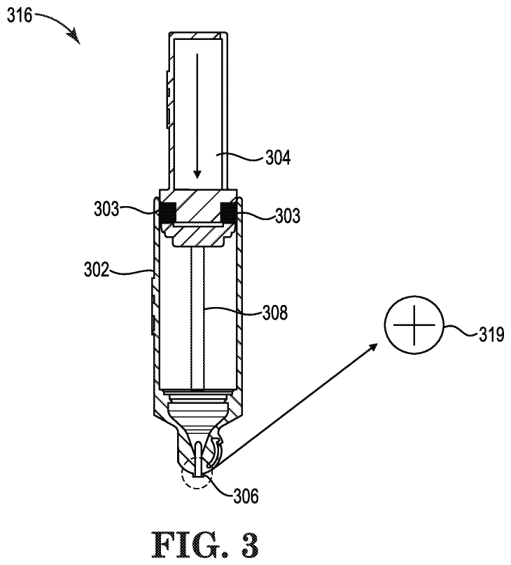

As illustrated in FIG. 1, pressure manipulation device 106 can be located on a “bottom” portion of print material particles container 100, as oriented in FIG. 1. Pressure manipulation device 106 can be a rupture barrier, translating bias gate, rotating bias gate, rotating gate secured by a latch, and/or material having a score line, among other types of pressure manipulation devices, as is further described herein with respect to FIGS. 3-9.

FIG. 2 illustrates a cross-sectional side view of an example of a print material particles container having a volume adapting structure 204 in various positions 210 consistent with the disclosure. The print material particles container can include print material reservoir 202, seal member 203, volume adapting structure 204, and print material particles 228.

As previously described in connection with FIG. 1, the print material particles container can include a print material reservoir 202 and volume adapting structure 204. Volume adapting structure 204 can be oriented in various positions 210 as illustrated in FIG. 2. For example, at first position 210-1, volume adapting structure 204 has not been depressed. At second position 210-2, volume adapting structure 204 has been depressed a particular distance up to the location of print material particles 228 in print material reservoir 202. Finally, at third position 210-3, volume adapting structure 204 has been depressed such that print material particles 228 have been output from print material particles container to an imaging device, as is further described herein.

At first position 210-1, volume adapting structure 204 has not been depressed. For example, the print material particles container can be shipped/stored for use with volume adapting structure 204 at first position 210-1. While volume adapting structure 204 is at first position 210-1, print material reservoir 202 can include a first portion 212 having a gas and a second portion 214 having print material particles 228. As used herein, the term “gas” refers to a substance (e.g., a fluid or combination of fluids) having molecular mobility and expansion properties. In some examples, the gas can be air. However, examples of the disclosure are not so limited. For example, the gas located in first portion 212 can be any other gas or combination of gasses.

While first portion 212 and second portion 214 are illustrated as being fixed, examples of the disclosure are not so limited. For example, if the print material particles container is moved to a different orientation, the shape/dimensions of first portion 212 and second portion 214 can change.

At second position 210-2, volume adapting structure 204 can be depressed such that the second portion 214 is present in print material reservoir 202. That is, volume adapting structure 204 can be moved from first position 210-1 to second position 210-2 to decrease a volume of print material reservoir 202. Decreasing the volume of print material reservoir 202 can cause a volumetric ratio of the gas and print material particles 228 to change. That is, decreasing the volume of print material reservoir 202 can push the gas (e.g., previously located in first portion 212 when volume adapting structure 204 is at first position 210-1) into the second portion 214 having print material particles 228 to fill interstitial spaces between the print material particles 228.

Changing the volumetric ratio of the gas and print material particles 228 can aerate print material particles 228. As used herein, the term “aerate” refers to causing gas to be integrated to fill interstitial space between particulates. For example, gas previously located in first portion 212 can be pushed into a space having print material particles 228 to fill interstitial space between particulates of the print material particles 228 as a result of volume adapting structure 204 moving from first position 210-1 to second position 210-2.

Aerating print material particles 228 can allow for print material particles 228 to be fluidized to allow for improved flow of the print material particles 228 from print material reservoir 202 to an imaging device relative to the print material particles 228 being compacted. Aerating print material particles 228 can prevent a user or other mechanism from having to agitate (e.g., shake, spin, stir, etc.) the print material particles container prior to outputting the print material particles 228 from the print material particles container.

Although not illustrated in FIG. 2 for clarity and so as not to obscure examples of the disclosure, a pressure manipulation device (e.g., pressure manipulation device 106) can be located on a “bottom portion” (e.g., as oriented in FIG. 2) of the print material particles container to prevent the print material particles 228 from being output until the volumetric ratio of the gas and print material particles 228 has been changed by the volume adapting structure 204. For example, the pressure manipulation device located on the bottom of the print material particles container can prevent the output of print material particles 228 by providing a force (e.g., a normal force) to counteract the pressure in print material reservoir 202 generated as a result of volume adapting structure moving from first position 210-1 to second position 210-2. Providing the force by the pressure manipulation device on the bottom of the print material particles container can allow for the gas to aerate the print material particles 228 prior to the print material particles 228 being output to the imaging device.

As described above, at second position 210-2, volume adapting structure 204 can be depressed such that print material particles 228 have been aerated by gas previously located in first portion 212. Aerated print material particles 228 can now be output to the imaging device, as is further described herein.

At third position 210-3, volume adapting structure 204 can be depressed such that print material particles 228 are output from print material reservoir 202 to an imaging device. For example, volume adapting structure 204 can be moved from second position 210-2 to third position 210-3 to cause the output of print material particles 228 through/around the pressure manipulation device.

As previously described in connection with FIG. 1, in some examples, the pressure manipulation device can be a device located on a bottom of the print material particles container. The pressure manipulation device can be a device which is interacted with by pressure in print material reservoir 202 in response to volume adapting structure 204 being moved to third position 210-3. For example, the pressure manipulation device can be a device located on a bottom of print material reservoir 202 such that, in response to pressure in print material reservoir 202 exceeding a pressure threshold, the pressure manipulation device can allow the output of print material particles 228 from print material reservoir 202 to an imaging device. The pressure manipulation device located on the bottom of the print material reservoir 202 can be a rupture barrier, translating bias gate, rotating bias gate, rotating gate secured by a latch, and/or other rupturable material, among other types of pressure manipulation devices, as is further described herein with respect to FIGS. 3-9.

In some examples, as previously described in connection with FIG. 1, the volume adapting structure 204 can include a push actuator. The push actuator can contact and/or rupture the pressure manipulation device to allow the output of print material particles 228 from print material reservoir 202 to an imaging device, as is further described herein with respect to FIGS. 3, 5, 7, and 8.

As illustrated in FIG. 2, the print material particles container can include seal member 203. Seal member 203 can prevent the flow of print material particles around volume adapting structure 204. The seal member 203 can hold the pressure in the print material particles reservoir 202 created by depressing volume adapting structure 204 and ensure that print material particles are forced into an imaging device through an outlet of the print material particles container and not around volume adapting structure 204 and into the ambient environment.

Although not illustrated in FIG. 2 for clarity and so as not to obscure examples of the disclosure, the print material particles container can be connected to an imaging device. The print material particles container can output print material particles 228 to the imaging device in response to volume adapting structure 204 moving from first position 210-1 to third position 210-3.

FIG. 3 illustrates a cross-sectional side view of an example of print material particles container 316 having a rupturable barrier 319 consistent with the disclosure. The print material particles container 316 can include print material reservoir 302, seal member 303, volume adapting structure 304, pressure manipulation device 306, and push actuator 308.

As illustrated in FIG. 3, print material particles container 316 can include push actuator 308 located in print material reservoir 302. Push actuator 308 can be attached to volume adapting structure 304 and can interact with pressure manipulation device 306, as is further described herein.

Pressure manipulation device 306 can be a rupturable barrier 319. As used herein, the term “rupturable barrier” refers to a non-reclosing pressure relief device having a material which breaks in response to a predetermined pressure on the material. For example, rupturable barrier 319 can be a rupture disc, rupture panel, and/or vent panel, although examples of the disclosure are not limited to the above listed rupturable barriers.

As illustrated in FIG. 3, rupturable barrier 319 can include rupture lines located in a central portion of rupturable barrier 319. The rupture lines can initiate/instigate the mode of pressure release under specific conditions, such as when contacted by push actuator, when pressure in print material reservoir exceeds a threshold pressure amount, etc. Rupturable barrier 319 can rupture at the rupture lines to allow output of print material particles, as is further described herein.

As previously described in connection with FIG. 2, volume adapting structure 304 can be depressed from a first position to a second position to aerate print material particles included in print material reservoir 302. As a result of volume adapting structure 304 being depressed to the second position, a volumetric ratio of the print material particles and gas in print material reservoir 302 can change and can result in a pressure increase in print material reservoir 302. Volume adapting structure 304 can further be depressed from the second position to a third position. While volume adapting structure 304 is depressed from the second position to the third position, push actuator 308 can rupture the rupturable barrier 319. As used herein, the term “rupture” refers to breaking of a material. For example, push actuator 308 can contact and then rupture the rupturable barrier 319 as volume adapting structure 304 is being depressed from the second position to the third position.

As described above, rupturable barrier 319 can be ruptured when push actuator 308 contacts rupturable barrier 319. The rupturable barrier 319 can rupture along the lines illustrated in FIG. 3 on rupturable barrier 319. That is, the lines shown on rupturable barrier 319 can be engineered weak points on rupturable barrier 319 to initiate a predetermined material failure of rupturable barrier 319 under specific conditions (e.g., push actuator 308 contacting and pressing through rupturable barrier 319). Rupturable barrier 319 can rupture by tearing and/or mechanical separation of the rupturable barrier material along the lines shown on rupturable barrier 319. Rupturable barrier 319 can fail when push actuator 308 contacts and presses through rupturable barrier 319 to allow for flow of print material particles without any shedding of the rupturable barrier material.

The print material particles container 316 can include seal member 303. Seal member 303 can prevent the flow of print material particles around volume adapting structure 304. The seal member 303 can hold the pressure in the print material particles reservoir 302 created by depressing volume adapting structure 304 and ensure that print material particles are forced into an imaging device through an outlet of the print material particles container and not around volume adapting structure 304 and into the ambient environment.

As rupturable barrier 319 is ruptured by push actuator 308, print material particles can be output from the print material reservoir 302 through the rupturable barrier 319. The print material particles can be output to an imaging device. When the volume adapting structure 304 is at the third position (e.g., as previously described in connection with FIG. 2), the print material particles can be all or substantially output to the imaging device.

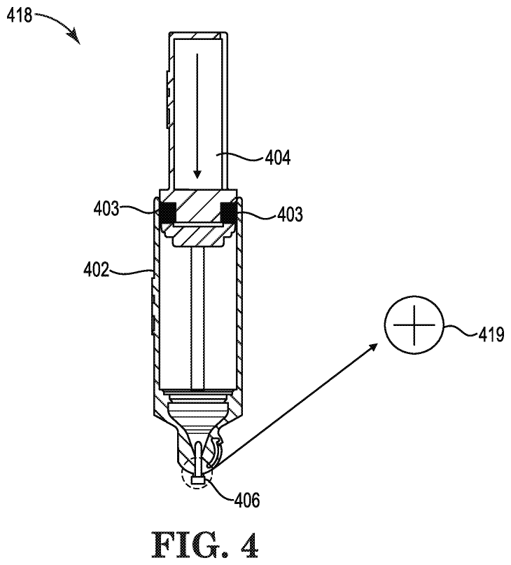

FIG. 4 illustrates a cross-sectional side view of an example of print material particles container 418 having a rupturable barrier 419 consistent with the disclosure. The print material particles container 418 can include print material reservoir 402, seal member 403, volume adapting structure 404, and pressure manipulation device 406.

As illustrated in FIG. 4, pressure manipulation device 406 can be a rupturable barrier 419. As illustrated in FIG. 4, rupturable barrier 419 can include rupture lines located in a central portion of rupturable barrier 419. Rupturable barrier 419 can rupture at the rupture lines to allow output of print material particles, as is further described herein.

As previously described in connection with FIG. 2, volume adapting structure 404 can be depressed from a first position to a second position to aerate print material particles included in print material reservoir 402. As a result of volume adapting structure 404 being depressed to the second position, a volumetric ratio of the print material particles and gas in print material reservoir 402 can change, and can result in a pressure increase in print material reservoir 402. Volume adapting structure 404 can further be depressed from the second position to a third position. While volume adapting structure 404 is depressed from the second position to the third position, the pressure in print material reservoir 402 can exceed a predetermined pressure threshold to cause rupturable barrier 419 to rupture. That is, rupturable barrier 419 can be designed to rupture at a predetermined pressure such that, when the pressure in print material reservoir 402 exceeds the predetermined pressure, rupturable barrier 419 can rupture.

As described above, rupturable barrier 419 can be ruptured when a pressure in print material reservoir 402 exceeds a predetermined pressure threshold. The rupturable barrier 419 can rupture along the lines illustrated in FIG. 4 on rupturable barrier 419. That is, the lines shown on rupturable barrier 419 can be engineered weak points on rupturable barrier 419 to initiate a predetermined material failure of rupturable barrier 419 under specific conditions (e.g., a pressure in print material reservoir 402 exceeding a predetermined pressure threshold). Rupturable barrier 419 can rupture by tearing and/or mechanical separation of the rupturable barrier material along the lines shown on rupturable barrier 419. Rupturable barrier 419 can fail when the pressure in print material reservoir 402 exceeds the predetermined pressure threshold to allow for flow of print material particles without any shedding of the rupturable barrier material.

The print material particles container 418 can include seal member 403. Seal member 403 can prevent the flow of print material particles around volume adapting structure 404. The seal member 403 can hold the pressure in the print material particles reservoir 402 created by depressing volume adapting structure 404 and ensure that print material particles are forced into an imaging device through an outlet of the print material particles container and not around volume adapting structure 404 and into the ambient environment.

As rupturable barrier 419 is ruptured by the pressure in print material reservoir 402 exceeding the predetermined pressure threshold as a result of volume adapting structure 404 moving to the third position, print material particles can be output from the print material reservoir 402 through the rupturable barrier 419. The print material particles can be output to an imaging device. When the volume adapting structure 404 is at the third position (e.g., as previously described in connection with FIG. 2), the print material particles can be all or substantially output to the imaging device.

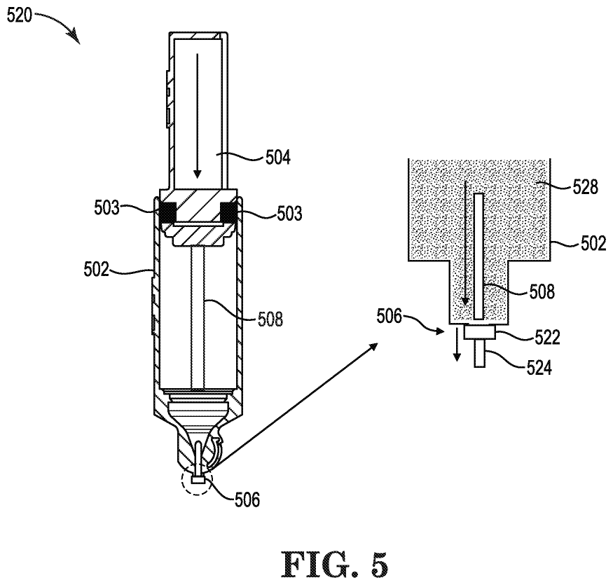

FIG. 5 illustrates a cross-sectional side view of an example of print material particles container 520 having a translating bias gate 522 consistent with the disclosure. The print material particles container 520 can include print material reservoir 502, seal member 503, volume adapting structure 504, pressure manipulation device 506, and push actuator 508.

As illustrated in FIG. 5, pressure manipulation device 506 can be a translating bias gate 522. As used herein, the term “translating bias gate” refers to a member which can be moved in a particular linear direction when the member overcomes a force. For example, translating bias gate 522 can be biased by a force via bias mechanism 524. In some examples, bias mechanism 524 can be a coil spring. As used herein, the term “coil spring” refers to a mechanical device that stores mechanical energy. For example, translating bias gate 522 can be moved in a particular direction by a force that can overcome the biasing force applied to translating bias gate 522 by bias mechanism 524 (e.g., by the coil spring).

Although bias mechanism 524 is described above as a spring, examples of the disclosure are not so limited. For example, bias mechanism 524 can be any other device to provide a force to translating bias gate 522.

As previously described in connection with FIG. 2, volume adapting structure 504 can be depressed from a first position to a second position to aerate print material particles 528 included in print material reservoir 502. As a result of volume adapting structure 504 being depressed to the second position, a volumetric ratio of the print material particles 528 and gas in print material reservoir 502 can change and can result in a pressure increase in print material reservoir 502. Volume adapting structure 504 can further be depressed from the second position to a third position. While volume adapting structure 504 is depressed from the second position to the third position, push actuator 508 can contact translating bias gate 522 and cause linear displacement of translating bias gate 522.

The print material particles container 520 can include seal member 503. Seal member 503 can prevent the flow of print material particles around volume adapting structure 504. The seal member 503 can hold the pressure in the print material particles reservoir 502 created by depressing volume adapting structure 504 and ensure that print material particles are forced into an imaging device through an outlet of the print material particles container and not around volume adapting structure 504 and into the ambient environment.

As translating bias gate 522 is displaced by push actuator 508, print material particles 528 can be output from the print material reservoir 502 around translating bias gate 522. The print material particles 528 can be output to an imaging device. When the volume adapting structure 504 is at the third position (e.g., as previously described in connection with FIG. 2), the print material particles 528 can be all or substantially output to the imaging device.

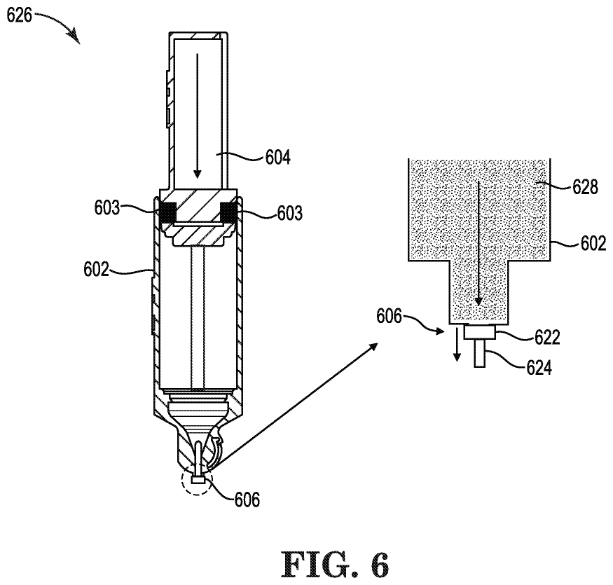

FIG. 6 illustrates a cross-sectional side view of an example of print material particles container 626 having a translating bias gate 622 consistent with the disclosure. The print material particles container 626 can include print material reservoir 602, seal member 603, volume adapting structure 604, and pressure manipulation device 606.

As illustrated in FIG. 6, pressure manipulation device 606 can be a translating bias gate 622. Translating bias gate 622 can be biased by bias mechanism 624.

As previously described in connection with FIG. 2, volume adapting structure 604 can be depressed from a first position to a second position to aerate print material particles 628 included in print material reservoir 602. As a result of volume adapting structure 604 being depressed to the second position, a volumetric ratio of the print material particles 628 and gas in print material reservoir 602 can change and can result in a pressure increase in print material reservoir 602. Volume adapting structure 604 can further be depressed from the second position to a third position. While volume adapting structure 604 is depressed from the second position to the third position, the pressure in print material reservoir 602 can exceed a predetermined pressure threshold to cause displacement of translating bias gate 622. That is, translating bias gate 622 and bias mechanism 624 can be designed to linearly translate at a predetermined pressure such that, when the pressure in print material reservoir 602 exceeds the predetermined pressure, bias mechanism 624 can be compressed as a result of linear translation of translating bias gate 622.

The print material particles container 626 can include seal member 603. Seal member 603 can prevent the flow of print material particles around volume adapting structure 604. The seal member 603 can hold the pressure in the print material particles reservoir 602 created by depressing volume adapting structure 604 and ensure that print material particles are forced into an imaging device through an outlet of the print material particles container and not around volume adapting structure 604 and into the ambient environment.

As translating bias gate 622 is displaced by the pressure in print material reservoir 602 exceeding the predetermined pressure threshold as a result of volume adapting structure 604 moving to the third position, print material particles 628 can be output from the print material reservoir 602 around translating bias gate 622. The print material particles 628 can be output to an imaging device. When the volume adapting structure 604 is at the third position (e.g., as previously described in connection with FIG. 2), the print material particles 628 can be all or substantially output to the imaging device.

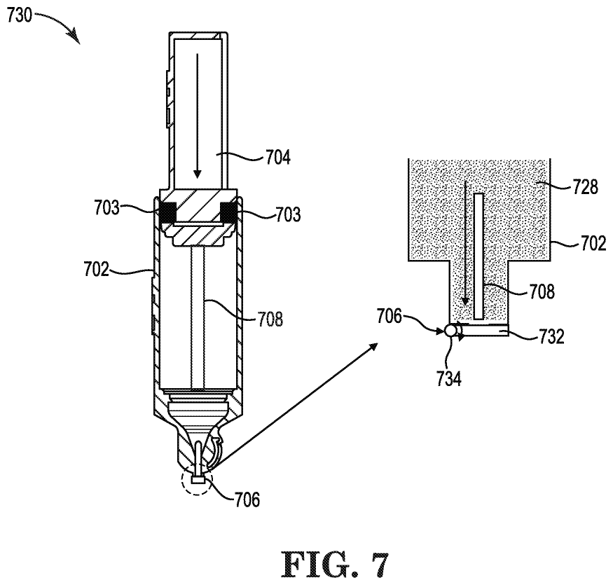

FIG. 7 illustrates a cross-sectional side view of an example of print material particles container 730 having a rotating bias gate 732 consistent with the disclosure. The print material particles container 730 can include print material reservoir 702, seal member 703, volume adapting structure 704, pressure manipulation device 706, and push actuator 708.

As illustrated in FIG. 7, pressure manipulation device 706 can be a rotating bias gate 732. As used herein, the term “rotating bias gate” refers to a member which can be rotated in a particular rotational direction when the member overcomes a force. For example, rotating bias gate 732 can be biased by a force via bias mechanism 734. In some examples, bias mechanism 734 can be a torsion spring. As used herein, the term “torsion spring” refers to a mechanical device that stores mechanical energy when twisted. For example, rotating bias gate 732 can be moved in a particular direction by a force that can overcome the biasing force applied to rotating bias gate 732 by bias mechanism 734 (e.g., by the torsion spring).

As previously described in connection with FIG. 2, volume adapting structure 704 can be depressed from a first position to a second position to aerate print material particles 728 included in print material reservoir 702. As a result of volume adapting structure 704 being depressed to the second position, a volumetric ratio of the print material particles 728 and gas in print material reservoir 702 can change and can result in a pressure increase in print material reservoir 702. Volume adapting structure 704 can further be depressed from the second position to a third position. While volume adapting structure 704 is depressed from the second position to the third position, push actuator 708 can contact rotating bias gate 732 and cause rotational displacement of rotating bias gate 732.

The print material particles container 730 can include seal member 703. Seal member 703 can prevent the flow of print material particles around volume adapting structure 704. The seal member 703 can hold the pressure in the print material particles reservoir 702 created by depressing volume adapting structure 704 and ensure that print material particles are forced into an imaging device through an outlet of the print material particles container and not around volume adapting structure 704 and into the ambient environment.

As rotating bias gate 732 is displaced by push actuator 708, print material particles 728 can be output from the print material reservoir 702 around rotating bias gate 732. The print material particles 728 can be output to an imaging device. When the volume adapting structure 704 is at the third position (e.g., as previously described in connection with FIG. 2), the print material particles 728 can be all or substantially output to the imaging device.

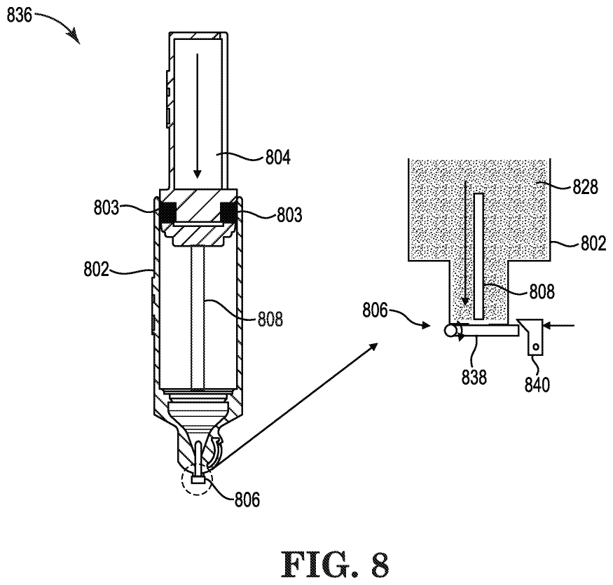

FIG. 8 illustrates a cross-sectional side view of an example of print material particles container 836 having a rotating gate 838 and latch 840 consistent with the disclosure. The print material particles container 836 can include print material reservoir 802, seal member 803, volume adapting structure 804, pressure manipulation device 806, and push actuator 808.

As illustrated in FIG. 8, pressure manipulation device 806 can be a rotating gate 838 secured by latch 840. As used herein, the term “rotating gate” refers to a member which can be rotated in a particular rotational direction when the member overcomes a force applied by a latch. As used herein, the term “latch” refers to a device to hold a gate. For example, rotating gate 838 can be held in place by latch 840 as a result of friction between rotating gate 838 and latch 840 caused by a force (e.g., applied in a “left” direction as oriented in FIG. 8) to gate 838 by latch 840.

As previously described in connection with FIG. 2, volume adapting structure 804 can be depressed from a first position to a second position to aerate print material particles 828 included in print material reservoir 802. As a result of volume adapting structure 804 being depressed to the second position, a volumetric ratio of the print material particles 828 and gas in print material reservoir 802 can change and can result in a pressure increase in print material reservoir 802. Volume adapting structure 804 can further be depressed from the second position to a third position. Mile volume adapting structure 804 is depressed from the second position to the third position, push actuator 808 can contact rotating gate 838 and cause rotating gate 838 to rotate away from latch 840.

The print material particles container 836 can include seal member 803. Seal member 803 can prevent the flow of print material particles around volume adapting structure 804. The seal member 803 can hold the pressure in the print material particles reservoir 802 created by depressing volume adapting structure 804 and ensure that print material particles are forced into an imaging device through an outlet of the print material particles container and not around volume adapting structure 804 and into the ambient environment.

As rotating gate 838 is displaced by push actuator 808, print material particles 828 can be output from the print material reservoir 802 around rotating gate 838. The print material particles 828 can be output to an imaging device. When the volume adapting structure 804 is at the third position (e.g., as previously described in connection with FIG. 2), the print material particles 828 can be all or substantially output to the imaging device.

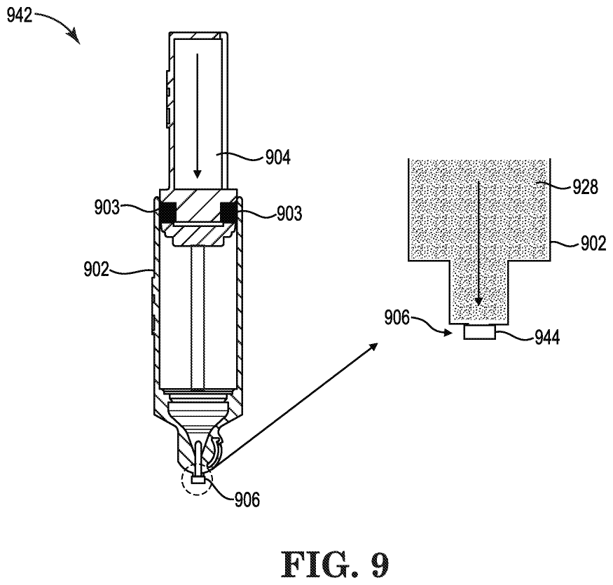

FIG. 9 illustrates a cross-sectional side view of an example of print material particles container 942 having a rupturable material 944 consistent with the disclosure. The print material particles container 942 can include print material reservoir 902, seal member 903, volume adapting structure 904, and pressure manipulation device 906.

As illustrated in FIG. 9, pressure manipulation device 906 can be a rupturable material 944. As used herein, the term “rupturable material” refers to a material which breaks in response to a predetermined pressure on the material. Rupturable material 944 can include a material having score lines, a thin material, and/or any other type of material which can rupture in response to a predetermined pressure on the material.

As previously described in connection with FIG. 2, volume adapting structure 904 can be depressed from a first position to a second position to aerate print material particles 928 included in print material reservoir 902. As a result of volume adapting structure 904 being depressed to the second position, a volumetric ratio of the print material particles and gas in print material reservoir 902 can change and can result in a pressure increase in print material reservoir 902. Volume adapting structure 904 can further be depressed from the second position to a third position. While volume adapting structure 904 is depressed from the second position to the third position, the pressure in print material reservoir 902 can exceed a predetermined pressure threshold to cause rupturable material 944 to rupture. That is, rupturable material 944 can be designed to rupture at a predetermined pressure such that, when the pressure in print material reservoir 902 exceeds the predetermined pressure, rupturable material 944 can rupture.

The print material particles container 942 can include seal member 903. Seal member 903 can prevent the flow of print material particles around volume adapting structure 904. The seal member 903 can hold the pressure in the print material particles reservoir 902 created by depressing volume adapting structure 904 and ensure that print material particles are forced into an imaging device through an outlet of the print material particles container and not around volume adapting structure 904 and into the ambient environment.

As rupturable material 944 is ruptured by the pressure in print material reservoir 902 exceeding the predetermined pressure threshold as a result of volume adapting structure 904 moving to the third position, print material particles 928 can be output from the print material reservoir 902 through the rupturable material 944. The print material particles 928 can be output to an imaging device. When the volume adapting structure 904 is at the third position (e.g., as previously described in connection with FIG. 2), the print material particles 928 can be all or substantially output to the imaging device.

Aerate print material particles according to the disclosure can allow for gas to aerate print material particles. Aerating print material particles can allow for improved flow of print material particles from a print material particles container. Accordingly, aerating print material particles can avoid compaction of print material particles such that print material particles can be output (e.g., to an imaging device) without shaking, stirring, or otherwise agitating the print material particles. Print material particles can quickly and easily be output to, for example, an imaging device allowing the imaging device to continue to perform print jobs.

In the foregoing detailed description of the disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the disclosure. Further, as used herein, “a” can refer to one such thing or more than one such thing.

The figures herein follow a numbering convention in which the first digit corresponds to the drawing figure number and the remaining digits identify an element or component in the drawing. For example, reference numeral 102 may refer to element 102 in FIG. 1 and an analogous element may be identified by reference numeral 202 in FIG. 2. Elements shown in the various figures herein can be added, exchanged, and/or eliminated to provide additional examples of the disclosure. In addition, the proportion and the relative scale of the elements provided in the figures are intended to illustrate the examples of the disclosure and should not be taken in a limiting sense.

It can be understood that when an element is referred to as being “on,” “connected to”, “coupled to”, or “coupled with” another element, it can be directly on, connected, or coupled with the other element or intervening elements may be present. In contrast, when an object is “directly coupled to” or “directly coupled with” another element it is understood that are no intervening elements (adhesives, screws, other elements) etc.

The above specification, examples and data provide a description of the method and applications, and use of the system and method of the disclosure. Since many examples can be made without departing from the spirit and scope of the system and method of the disclosure, this specification merely sets forth some of the many possible example configurations and implementations.

What is claimed is:

1. A print material particles container, comprising:
a print material reservoir;
a structure adapted to decrease a volume of the print material reservoir to provide an output of print material particles; and
a pressure manipulation device adapted to be manipulated while the volume adapting structure is moved from a first position to a third position to aerate the print material particles.

2. The print material particles container of claim 1, wherein the print material reservoir includes:
a first portion having a gas; and
a second portion having the print material particles.

3. The print material particles container of claim 2, wherein the volume adapting structure is adapted to be moved from the first position to a second position such that the volume adapting structure changes a volumetric ratio of the gas and the print material particles in the print material reservoir to aerate the print material particles.

4. The print material particles container of claim 3, wherein the volume adapting structure is adapted to provide the output of print material particles through the pressure manipulation device while the volume adapting structure is moved from the second position to the third position.

5. The print material particles container of claim 1, wherein the volume adapting structure is adapted to provide the output of print material particles while the volume adapting structure is moved from the first position to the third position to cause pressure to exceed a predetermined pressure threshold.

6. A print material particles container to output print particles, comprising:
a print material reservoir;
a structure adapted to decrease a volume of the print material reservoir to cause output of print material particles; and
a pressure manipulation device adapted to be manipulated in response to the volume adapting structure being moved from a first position to a third position to:
change a volumetric ratio of the gas and the print material particles in the print material reservoir; and
cause the output of the print material particles.

7. The print material particles container of claim 6, wherein:
the pressure manipulation device is a rupturable barrier; and
the volume adapting structure includes a push actuator such that while the volume adapting structure is moved from the first position to the third position the push actuator ruptures the rupturable barrier to cause the output of the print material particles through the rupturable barrier.

8. The print material particles container of claim 6, wherein:
the pressure manipulation device is a rupturable barrier; and
a pressure in the print material reservoir on the rupture disc exceeding the predetermined pressure threshold causes the rupturable barrier to rupture to cause the output of the print material particles through the rupturable barrier.

9. The print material particles container of claim 6, wherein:
the print material reservoir includes a translating bias gate; and
the volume adapting structure includes a push actuator such that while the volume adapting structure is moved from the first position to the third position the push actuator contacts the translating bias gate to cause displacement of the translating bias gate to cause the output of the print material particles from the print material reservoir.

10. The print material particles container of claim 6, wherein:
the print material reservoir includes a translating bias gate; and
a pressure from the pressure in the print material reservoir on the translating bias gate exceeding the predetermined pressure threshold causes displacement of the translating bias gate to cause the output of the print material particles from the print material reservoir.

11. The print material particles container of claim 6, wherein:
the print material reservoir includes a rotating bias gate; and
the volume adapting structure includes a push actuator such that while the volume adapting structure is moved from the first position to the third position the push actuator contacts the rotating bias gate to rotate the rotating bias gate to cause the output of the print material particles from the print material reservoir.

12. The print material particles container of claim 6, wherein:
the print material reservoir includes a rotating gate secured by a latch; and
the volume adapting structure includes a push actuator such that while the volume adapting structure is moved from the first position to the third position the push actuator contacts the rotating gate to cause the latch to disengage to allow the rotating gate to rotate to cause the output of the print material particles from the print material reservoir.

13. The print material particles container of claim 6, wherein:
the pressure manipulation device is a rupturable material; and
a pressure in the print material reservoir on the rupturable material exceeding the predetermined pressure threshold causes the rupturable material to rupture to cause the output of the print material particles through the rupturable material.

14. A system, comprising:
a print material reservoir including a first portion with gas and a second portion with print material particles;
a structure adapted to decrease a volume of the print material reservoir to cause output of the print material particles to an input of an imaging device; and
a pressure manipulation device adapted to be manipulated to cause the output of the print material particles;
wherein:
while the volume adapting structure is moved from a first position to a second position, a volumetric ratio of the gas and print material particles in the print material reservoir is modified; and
while the volume adapting structure is moved from the second position to a third position, a push actuator connected to the volume adapting structure causes the print material particles to be output to the input of the imaging device.

15. The system of claim 14, wherein the print materials particles container is connected to the imaging device such that the print materials particles are supplied from the print material reservoir to the imaging device in response to the volume adapting structure being moved from the first position to the third position.
